(19) United States
(12) Patent Application Publication
(10) Pub. No.: US 2005/0076357 A1
(43) Pub. Date: Apr. 7, 2005

(54) Dynamic insertion of targeted sponsored video messages into Internet multimedia broadcasts

(76) Inventor: Adam Michael Fenne, San Juan Capistrano, CA (US)

Correspondence Address: HOWREY SIMON ARNOLD & WHITE, LLP, c/o IP DOCKETING DEPARTMENT, 2941 FAIRVIEW PARK DRIVE, SUITE 200, FALLS CHURCH, VA, 22042-2924, US

(21) Appl. No.: 10/875,817

(22) Filed: Jun. 24, 2004

Related U.S. Application Data
(63) Continuation of application No. 09/428,387, filed on Oct. 28, 1999.

(51) Int. Cl. H04N 7/16; H04N 7/10; H04N 7/025; H04H 9/00

(52) U.S. Cl. 725/14; 725/9; 725/34; 725/35

(57) ABSTRACT

At least first and second potential viewers deliver their personal demographic informations to a processing system (Internet processing server). Viewing information concerning their television or computer multimedia viewing habits are entered automatically from their respective viewing stations into the processing system. From this demographic and viewing information, the processing system determines pursuant to pre-determined criteria incorporated into processing system software the desired sponsored video message (advertisement), which is played when that viewer views multimedia at his/her viewing station. In other words, the video advertisements shown are selected for the individual viewer, and this determination is a dynamic determination based at least in part on the most recent viewing behavior of that viewer. The message can be pre-cached at the viewing station and shown when the multimedia content is not “available” for viewing at the station, and particularly when an initial portion of the multimedia content is being downloaded for later presentation at the station. Additionally, from all of the information delivered to the processing system, valuable viewer/viewing information can be processed and made available to a recipient.

### BACKGROUND OF THE INVENTION

1. Field of the Invention

The present invention relates to systems and methods for effectively targeting sponsored video messages (advertisements) to Internet multimedia and other broadcasts and inserting them into the broadcasts.

2. Description of Related Art

Information concerning broadcast viewers and viewing habits is important to advertisers in deciding what commercials to broadcast, when to broadcast them and how much to pay for the right to have them broadcast. A well-known system for gathering information on television viewing is the Nielsen TV rating service. The Nielsen service estimates the audience watching particular television programs by drawing a sample and then counting the number of viewers in the sample, and by obtaining demographic information on the viewers. All of the televisions in the sample households are connected to meters that keep track of when the sets are on and to what they are tuned. Information from all of the meters is transmitted to the Nielsen central computers each night.

The Nielsen system can include “People Meters” having different buttons for each specific member of the household. Each member then activates and deactivates his/her button when he/she turns the television on and off. This member-button information is transmitted each night as well to the central computers.

Another Nielsen monitoring system has viewers in the sample keep track of their viewing activities by writing when and what they are watching in personal diaries. The diaries are then mailed into Nielsen, which transfers the information into their computers to calculate “ratings.” The information from the diaries is cross-checked with that from the People Meters at the Nielsen offices.

As can be appreciated, the information obtained from the Nielsen system is limited and the collection, analysis and distribution of the results are slow.

A prior art system for targeting and inserting advertisements are pop-up, banner and other advertisements which appear as part of or in conjunction with web pages in response to viewer's queries. These advertisements can be selected independent of the particular viewer or can be selected in response to the specific query. For example, if the subject matter of a query is “soft drink”, an advertisement for a specific soft drink may appear on the web page.

A further prior art system for limited targeting of advertisements is where a viewer inserts personal information on a web page and (still) advertisements responsive to that information appear on the computer screen.

### SUMMARY OF THE INVENTION

Directed to remedying the shortcomings and problems in the prior art, disclosed herein is a system and method for selecting a video advertisement targeted to a specific viewer based on information specific to that viewer. This targeted advertisement is then shown at a viewing station which the viewer is watching together with the multimedia content (e.g., movie, television show, news program, music and music video) being watched. The informations that are analyzed can include two general categories: (1) demographic/personal information on the viewer and (2) information on the viewing behavior of that viewer. The viewing behavior can include the media watched, the time and frequency of watching, and the location and type of viewing station. The viewing information is continually updated each time the viewer logs onto a viewing system. The database of advertisements from which the selection is made is also periodically changed or updated. Thus, the present video advertisement targeting system is a dynamic system, specifically targeted to each viewer depending on his/her personal demographic and viewing behavior.

Also disclosed herein is a system and method of timing of the presentation of sponsored messages and particularly the specifically-targeted messages relative to the presentation of the multimedia content. This content can, for example, be video-on-demand delivered over the Internet. For various technical reasons, the transmission of video material over the Internet is often not smooth and continuous; there are breaks and delays in the transmission. For that reason, many systems do not start presenting the multimedia content until an initial small or large portion thereof has already been received and downloaded or pre-cached. This provides a backlog or reserve when breaks are encountered. If additional breaks are encountered this is frustrating to the viewer who is now viewing a blank or “still,” frozen or distorted screen.

Accordingly, pursuant to a feature of this invention sponsored messages are presented during these multimedia “unavailable” times. The messages can be presented as they are being delivered to the viewing station (“streaming”) or they can be first pre-cached, waiting and available for presentation during the times when the multimedia is unavailable. The messages can be selected, delivered and pre-cached immediately upon the viewer accessing the website and logging on, while he/she is selecting the multimedia content to be viewed or is performing other operations. The (video) messages can be presented while the initial multimedia portion is being downloaded or when there is a break in the receipt of the multimedia as it is being transmitted over the Internet, or at predetermined times. Thereby a continuous video (advertisement and multimedia) presentation is advantageously made at the viewing station.

Other objects and advantages of the present invention will become more apparent to those skilled in the art from the foregoing description taken in conjunction with the following drawings.

### BRIEF DESCRIPTION OF THE DRAWINGS

FIG. 1 illustrates in block form components of a system of the present invention;

FIG. 2 illustrates in block form functional components of a viewing station of the system of FIG. 1;

FIG. 3 illustrates in block form functional components of a multimedia content server of the system of FIG. 1;

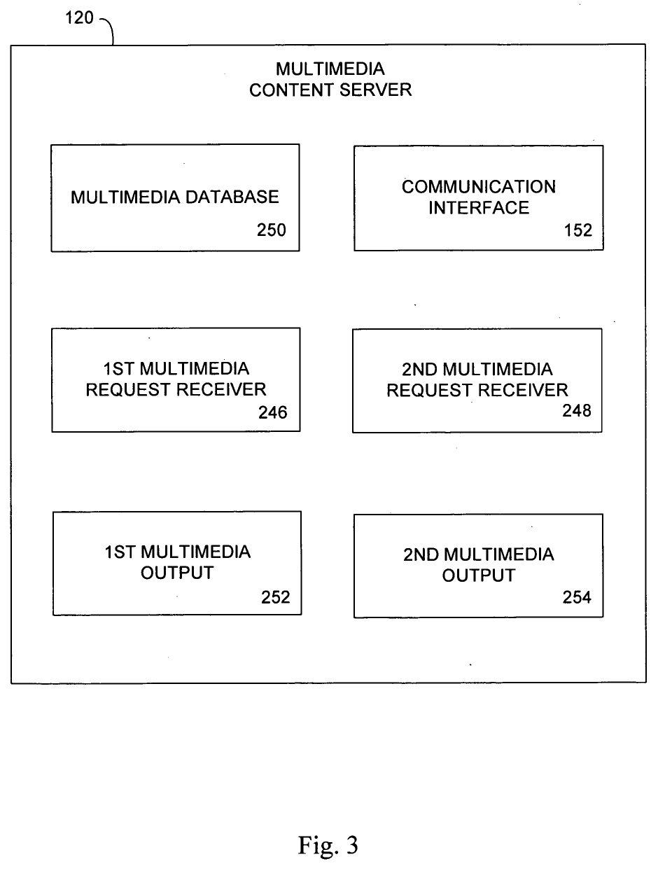

FIG. 4 illustrates in block form functional components of a sponsored video message server of the system of FIG. 1;

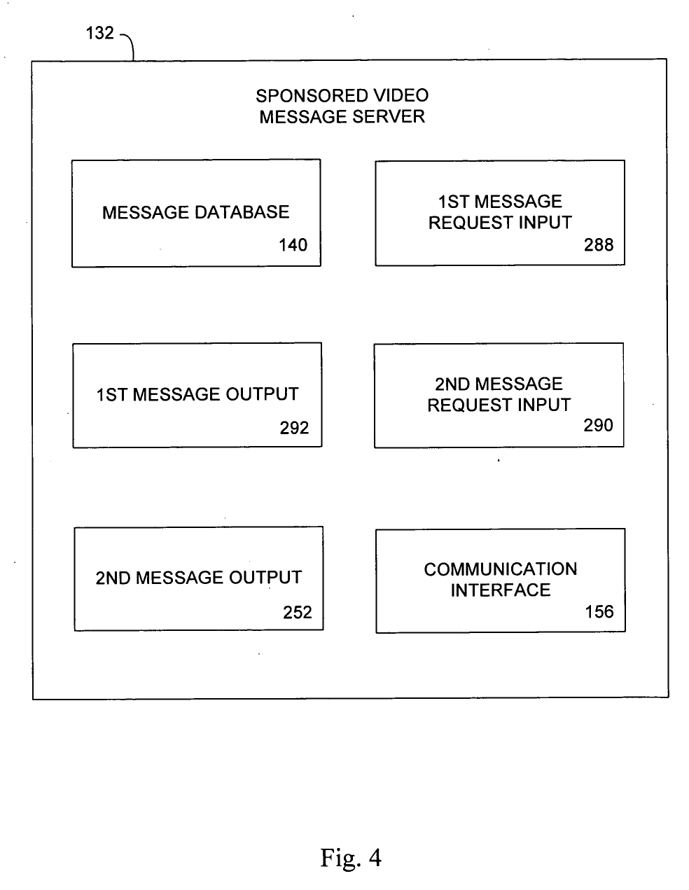

FIG. 5 illustrates in block form functional components of a processing server of the system of FIG. 1;

FIG. 6 illustrates in block form functional components of a recipient assembly of the system of FIG. 1; and

FIG. 7 is a flow chart showing a process which can be used with the system of FIG. 1.

### DETAILED DESCRIPTION OF PREFERRED EMBODIMENTS OF THE INVENTION

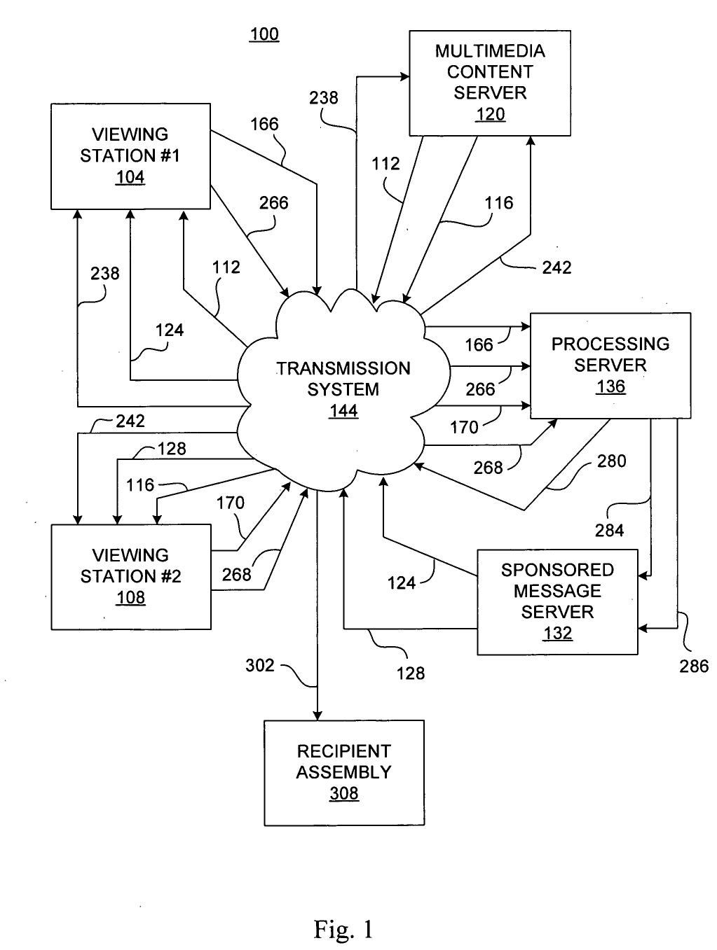

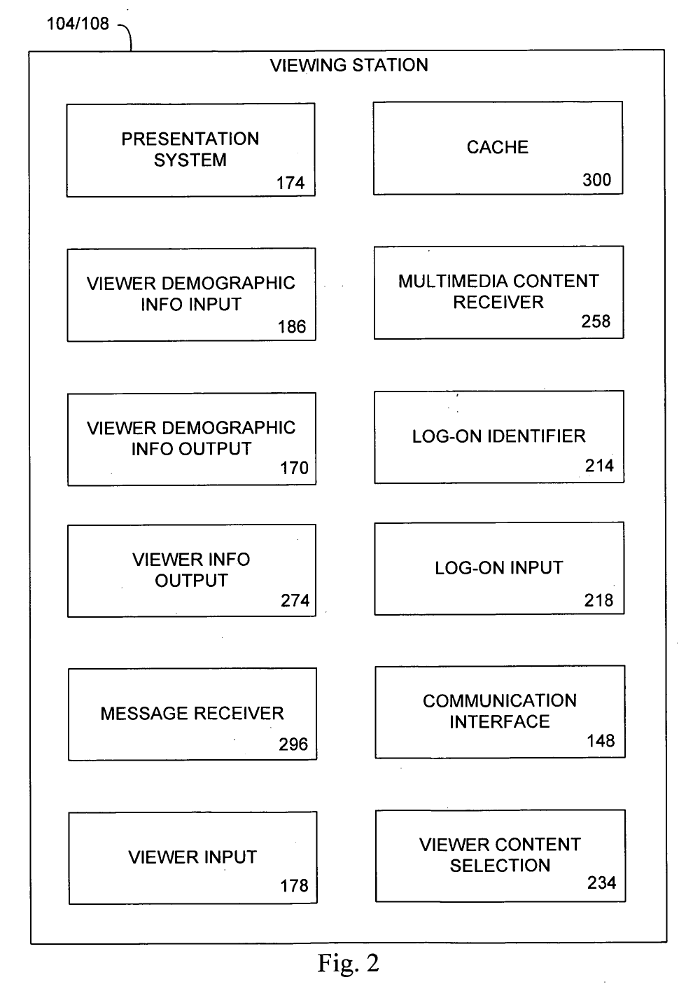

A system of the present invention is illustrated generally at 100 in FIG. 1. Referring thereto while only viewing stations 104 and 108 are illustrated, it is anticipated that the system will include hundreds, thousands, tens of thousands or even more viewing stations. Alternatively, it can include a single viewing station. Each viewing station can be viewed by a single person or by a plurality of viewers. The viewing stations are preferably personal computer systems, as will be described in greater detail with regard to FIG. 2. However, they can alternatively be television set stations, and the multimedia displayed on them can be a video-on-demand system.

The viewing stations 104, 108 receive the respective first and second multimedia contents 112, 116 (which can be the same or different) preferably from a multimedia content server 120. And the viewing stations receive the respective first and second sponsored messages (advertisements) 124, 128 from a sponsored message server 132. Additionally, the messages 124, 128 are preferably video messages (including audio components) as opposed to simply a “still” (and silent) message. Alternatively, the messages can be sound or video alone. The messages are likely different but can be the same as will be explained in greater detail later. Also, the messages delivered are selected preferably by a processing server 136 from a database of messages 140 associated with the server.

The multimedia content server 120, the message server 132 and the processing server 136 are operatively connect with the viewing stations 104, 108 through a transmission system, shown generically in FIG. 1 at 144. System 144 is preferably a bi-directional system, and the bi-directional system preferably is the Internet. Each of the servers and stations connects to the Internet through a respective communication interface 148, 152, 156, 158, as is known by those skilled in the art. The servers can be single machines or several machines.

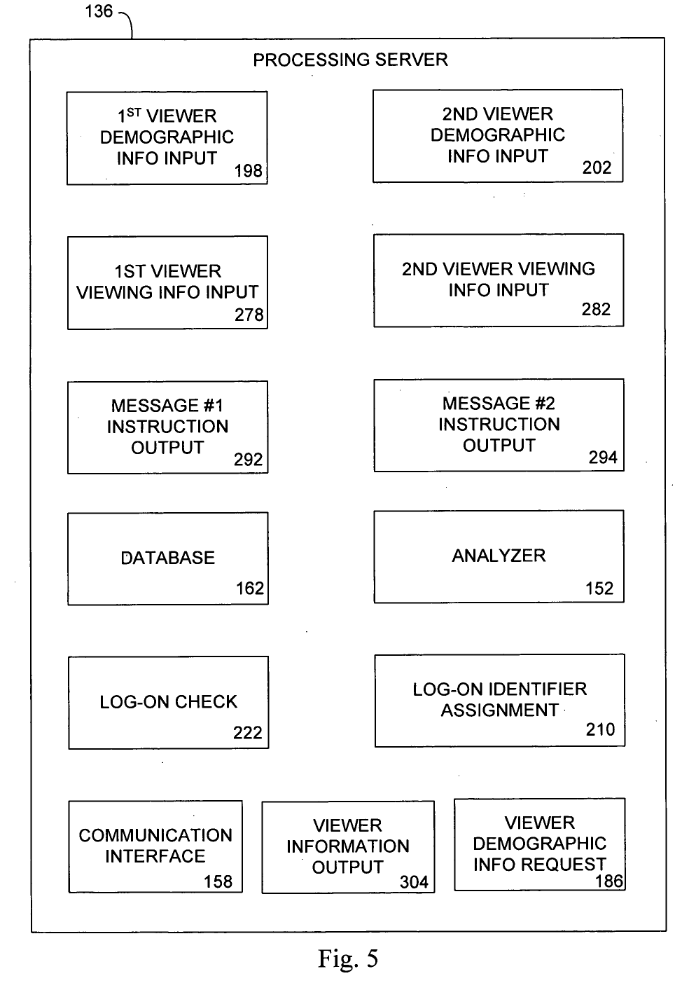

The processing server 136 considers numerous and varied items of information about each specific viewer and typically maintained in a database 162 in its decision as to what message to select from the database 140 for delivery to the viewing station 104 or 108 of that viewer. The decisions are made pursuant to a computer program in the “analyzer” 152, as depicted in FIG. 5, and the algorithms used therein would be typically supplied by or designed for the advertisers.

When a new viewer first enters the system 100, he/she delivers his/her demographic or personal information 166, 170 into the system. This is preferably done at one of the viewing stations 104, 108 by delivering up from the processing server 136 a web page which includes a form to be filled out at the respective viewing station. The form asks certain personal information of the viewer such as by filling in blanks on the monitor of the presentation system 174 at the viewing station 104, 108, which the user completes using the viewer input 178. The user input 178 can include a keyboard, a mouse, a microphone or any other computer user input device as is known. The information 166, 177 requested of the viewer can include his/her sex, age, income, residential zip code, occupation and so forth. Pursuant to a preferred embodiment it would not include his/her name to maintain his/her privacy and to encourage him/her to complete the form and anonymously enter the system. To further encourage participation, the system may include that a gift (such as personalized mouse pads, videos and clothing) will be sent to the viewer upon completion of the form or otherwise submitting the personal information into the system. Instead of entering the demographic/personal information on line, the potential viewer can phone or mail the information in for entry into the system.

The viewer demographic information request is made at the processing server 136 when a potential viewer first accesses the viewing station 104 or 108 (or more particularly accesses the website of the system 100) to the Viewer Demographic Information Input 186 at the viewing station 104 or 108 (that is, the form appears on the viewer's monitor). And the Viewer's Demographic Information Output is shown by reference numeral 194, which may be the viewer's completion of the form and transmitting it to the Demographic Information Input Receivers 198, 202 at the processing server 136.

As soon as the viewer submits his/her demographic information 166, 170 and it is transmitted to the processing server 136, a Log-On Identifier Assignment 210 is made and transmitted to the viewing station as a Log-On Identifier for transmission to the viewer. The identifier can be a random alphanumeric identifier, can be a log-on identifier or password chosen by the viewer (and not yet assigned to another viewer) or any other identification system known in the art. Thus, when the viewer desires to enter system 100, he/she turns on the viewing station 104 or 108, calls up the system website and enters his/her identifier (password) (see Log-On Input 218 in FIG. 2) (and name typically). A check is made by Log-On Check 222 at the processing server 136 and if the password is correct, he/she can proceed.

The viewer once logged on selects the desired multimedia content 226, 230 he/she wants to view at Viewer Content Selector 234, as by clicking on the icon appearing on the computer monitor screen which corresponds to the desired media content. This selection is then transmitted as shown by reference numerals 238, 242 to the First and Second Multimedia Request Receivers 246, 248 at the multimedia content server 120. The selected multimedia from the Multimedia Database 250 is transmitted from the Selected Multimedia Output means 252, 254 at the Multimedia Content Server 120 to the Multimedia Content Receiver 258 at the viewing station 104, 108 and presented by the Presentation System 174 to the viewer. The Presentation System 174 can include a monitor (or screen) and one or more speakers. A less preferred alternative is for the viewer to have no choice as to the multimedia he/she views, similar to having a single-channel television.

The viewing informations 266, 268 on each of the viewers at the viewing stations 104, 108 are transmitted from the Viewer Information Output 274 at the viewing stations to the Viewing Information Inputs 278, 282 at the processing server 136. The processing server 136 distinguishes the viewing information between (or among) different viewers based on their log-on identifiers. In other words, it does not matter what viewing station the viewer is using, the processing server 136 recognizes him/her by the log-on identifiers and associates the viewing information with the corresponding viewer. A less preferred alternative is to have each viewer assigned to a specific different viewing station.

The viewing informations 266, 268 can include the program or multimedia contents being viewed, the dates and times of viewing (such as the type of program, e.g., sports, educational and music video, and the type of audience to which the program generally appeals, e.g., young children, scientists and housewives) and the modem downloading speed. The processing server 136 can store the viewer demographic information 166, 170 and/or the viewing informations 266, 268 in the database 162. The informations are then processed in the analyzer 152 pursuant to a computer program which weighs different criteria and information and selects from the message database 140 an appropriate message to be transmitted to the specific viewer and specifically targeted to him/her. It sends the message instructions 284, 286 to the Message Request Inputs 288, 290 in the server 132. Using Message Outputs 292, 294, the selected specific sponsored messages 124, 128 are delivered to the specific viewers at their respective viewing stations. The messages are received at the Message Receiver 296 at the viewing station and may be stored in a cache 300 at the station. At the appropriate time, the message 124, 128 is presented on the presentation system 174 to the viewer. The message 124, 128 can be presented before, during, at breaks in and/or after the presentation of the multimedia content being displayed by the presentation system 174.

The viewing informations 266, 268 are continually being updated as the viewers continue to view the multimedia and each time they log onto the system 100. Thus, the message 124, 128 selected may vary at a later time because of the subsequent viewing information added to the determination. This dynamic feature of the present invention may be better understood in conjunction with the description of the process provided later.

The message 124, 128 may also vary depending on the messages available in the message database 140. Alternatively, the analyzer 152 may not select the message from the database 140 but rather transmit processed viewer information to a processor in the message server 132, which then selects the message. A further alternative is to provide the message server 132 and the processing server 136 as a single server unit. An even further alternative is to provide the multimedia content server 120 and the message server 132 as a single server, or even all three servers as a single machine.

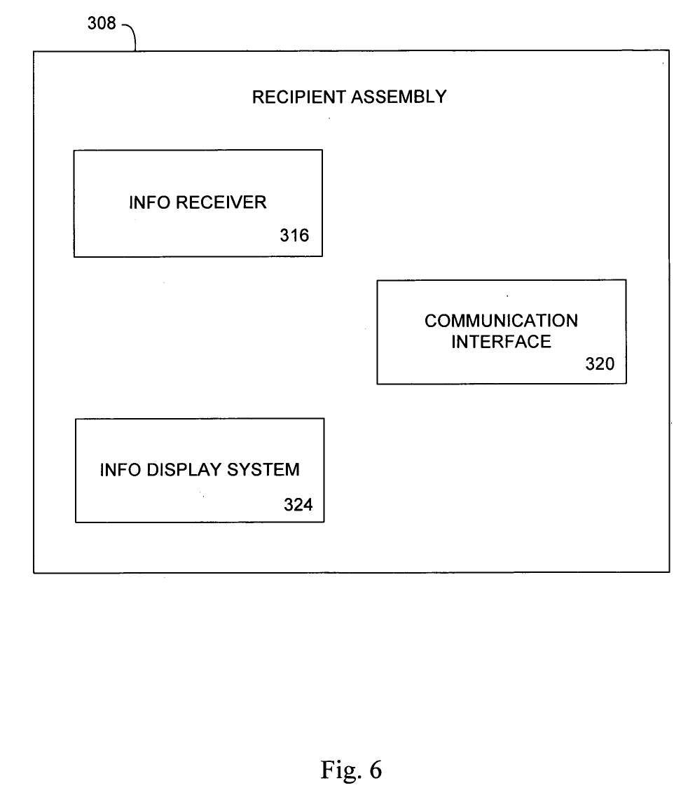

A further feature of this invention is that some or all of the viewing and demographic informations 302 can be output from the Tabulated Viewing Information Output 304 of the processing server 136 and transmitted to a recipient assembly 308 where it is received by an Information Receiver 312. The recipient assembly 308 is similarly connected to the transmission system (e.g., Internet) 144 via a communication interface 320. The informations 302 can be raw data or can be processed and/or tabulated information; they can include only part or all of the available viewing and demographic information. The informations 302 are then displayed at an Information Display System as depicted by reference numeral 324 in FIG. 6. The display system 324 can be a display on a computer monitor, a paper print out, an audio reading or other display as would be known by those skilled in the art. The information 302 may be what multimedia content a specific viewer who saw a specific sponsored message last week is watching this week. The recipient may be the advertiser or the broadcaster, and the display system may be at the recipient's offices.

The steps of a process of a viewer using the system 100 are now described. The (potential) viewer enters his/her demographic/personal information into the system and he/she is assigned a log-in identifier. The viewer then logs into a viewing station using the identifier and selects the (first) desired multimedia content and views it at the viewing station, for example video-on-demand shown at a personal computer linked to the Internet. In conjunction with the display of the multimedia content the (first) sponsored video message is presented and viewed by the viewer. After watching the multimedia and selected message, he/she logs off of the viewing station. At a later time, he/she logs onto the same or different viewing station again using his/her identifier. He selects and watches the (second) desired multimedia content (which may or may not be the same as the first). And in conjunction with the second multimedia content presentation, he/she views a second message at the station.

The second message may or may not be the same as the first. In fact, it will likely be different because his/her viewing profile information has changed in view of the first viewing and the fact that this is a second viewing and further in view of the fact that the message database may have changed in the interim. In other words, the messages presented to each viewer are preferably selected based in part on the viewer's personal information and are dynamically chosen based on his/her entire viewing information history. For example, if he/she first watches a daytime soap opera and then for his/her next few viewings watches night time horror shows, his/her viewing information has changed (his/her behavioral tracking profile) and this will likely affect the next message selected by the system. Thus, the (video) advertisement made available to the viewer will be carefully selected and targeted for him/her. The advertising process is thereby made more effective and economical. And even the viewer will likely be pleased that he/she is viewing only advertisements carefully selected for him/her. The selected advertisement can even be entirely independent of the multimedia content then being viewed and would likely differ for different viewers then viewing the same content.

Another invention or aspect of the invention disclosed herein is the pre-caching of the selected message so that it is available for presentation at the viewing station 104, 108 when the selected multimedia content is “unavailable,” or in anticipation of it being unavailable. There are a number of technical reasons why multimedia content may not be smoothly and continuously transmitted over the Internet 144 from a server and received ready for presentation at the viewing station. It is distracting to the viewer and undesirable for there to be a break or hiatus in the presentation of the multimedia content because of breaks or delays in transmission. Thus, it is known to first download or cache a small or large portion of the multimedia content so that there is a reserve available to access when the breaks or delays occur. However, this downloading takes time, boring time for the viewer who may just be staring at the screen. Accordingly, pursuant to an embodiment of this invention, the pre-cached message is presented during this downloading time to take advantage of the time and to keep the viewer entertained.

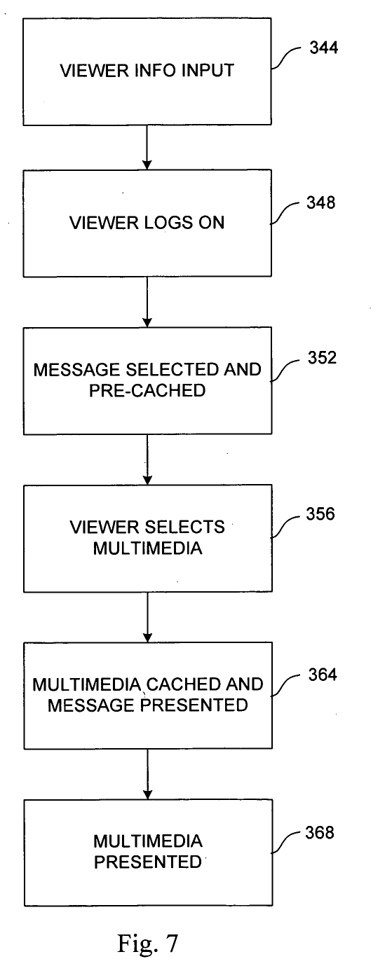

Thus, referring to FIG. 7, a system of this invention is illustrated generally at 340. The viewer's viewing information and demographic information are input into the system as previously described, and as shown by block 344. Block 348 shows the viewer logging on at his/her viewing station using his/her identifier, also as previously described. The sponsored video message is selected by the processing server 136, delivered to the viewing station and pre-cached there, as depicted by block 352. The viewer having logged on is at the website and looking at the catalog of available multimedia contents to decide which he/she wants to view. And it is during this time, that the pre-caching can occur, more fully utilizing the available bandwidth. The viewer then selects the multimedia he/she wants to view as depicted by block 356. The selected multimedia is retrieved from the database 250 in the multimedia server 120; while a small or large portion thereof is being cached the pre-cached message is presented to the viewer at the viewing station as depicted in block 364. And then referring to block 368, the multimedia content is presented at the station.

Instead of presenting the pre-cached message before the multimedia content is presented, it can be presented during the presentation. It can be presented at the point where the system detects that the cache of multimedia content available is below a predetermined amount or when the cache depletion rate exceeds a predetermined speed (as detected by a software program at the viewing station). However, this presentation at essentially random points in the multimedia presentation might be distracting to the viewer and might confusingly disrupt the presentation. Accordingly, an alternative embodiment provides for predetermined break points in the multimedia which are least disruptive to the presentation (similar to points chosen for television commercials). Then, if the system determines the cache is getting low, it can at the next predetermined break point insert the message. Then while the message is being presented, additional multimedia content will be cached.

The message can be taken from the pre-cache or can be taken directly off of the message stream being transmitted. A further alternative, if the available bandwidth is sufficient, is for the message to be delivered to the pre-cache simultaneously with the transmission of the multimedia content, the multimedia content being delivered either for immediate presentation or to a cache. Again, this message can be the targeted pre-selected message or can be a generic message shown to all viewers of that multimedia content or shown to all viewers at that time of any multimedia content.

From the foregoing detailed description, it will be evident that there are a number of changes, adaptations and modifications of the present invention which come within the province of those skilled in the art. For example, the same message may be presented more than once during the multimedia presentation and/or different messages (preferably specifically targeted messaged) may be presented. However, it is intended that all such variations not departing from the spirit of the invention be considered as within the scope thereof.

1. An Internet message delivery method, comprising:
(a) logging in a first viewer from one or more viewing stations, wherein said viewing station further comprises a personal computer operatively connected to the Internet;
(b) delivering viewing behavior information of the first viewer from one or more viewing stations which the first viewer is using to a processing system, wherein the processing system and the viewing station are operatively connected to each other through the Internet;
(c) delivering demographic information regarding the first viewer to the processing system;
(d) logging in a second viewer from one or more viewing stations of (a);
(e) delivering viewing behavior information of a second viewer from one or more viewing stations which the second viewer is using to the processing system;
(f) delivering demographic information regarding the second viewer to the processing system;
(g) processing at the processing system the viewing behavior information of the first viewer and demographic information regarding the first viewer delivered to the processing system to select a first viewer multimedia message targeted to the first viewer;
(h) processing at the processing system the viewing behavior information of the second viewer and demographic information regarding the second viewer delivered to the processing system to select a second viewer multimedia message targeted to the second viewer; and
(i) delivering the first viewer multimedia message to a viewing station of the first viewer.

2-5. (canceled)

6. The method of claim 1 wherein (b) includes the viewing behavior defining first viewing behavior and the using is at a first use time, and (g) includes the message defining a first message; and further comprising:
(j) delivering second viewing behavior information of the first viewer from a viewing station, which the first viewer is using at a second use time after the first use time, to the processing system, wherein the viewing station is operatively connected to the processing system through the Internet;
(k) processing, at the processing system, at least the demographic information of the first viewer and the second viewing behavior information of the first viewer to select a first viewer multimedia second message; and
(l) delivering the second message to a viewing station of the first viewer for viewing thereat.

7. The method of claim 6 wherein (l) includes delivering the second message during the delivery of multimedia content to the viewing station of the first viewer.

8. The method of claim 7 wherein (k) includes the processing being independent of the multimedia content.

9. The method of claim 1 further comprising delivering the second viewer multimedia message to a viewing station of the second viewer.

10. The method of claim 1 wherein (i) includes delivering the message with multimedia content to the viewing station of the first viewer.

11. The method of claim 1, wherein (b) includes the viewing behavior information including downloading speed information of the viewing station which the first viewer is using.

12. The method of claim 1, wherein (i) includes the viewing station including a television.

13. The method of claim 12 wherein (b) includes the viewing station including a video-on-demand system.

14. (canceled)

15. The method of claim 1 wherein the first multimedia message is a video message.

16. The method of claim 1 wherein the viewing behavior is video viewing behavior.

17. The method of claim 1 wherein (b) includes the viewing behavior information including the time of viewing by the first viewer.

18. The method of claim 1 wherein (b) includes the viewing behavior information including the length of viewing time of the first viewer at the viewing station.

19. The method of claim 1 wherein (i) includes presenting the first viewer multimedia messages when there is a break in the availability of the multimedia content for presentation at the viewing station.

20. The method of claim 1 wherein (i) includes delivering the first viewer multimedia message to the viewing station simultaneously with the delivery of the multimedia content thereto.

21. The method of claim 1 wherein (i) includes pre-caching the first viewer multimedia message for presentation at the viewing station when multimedia content to be viewed is generally not available for presentation.

22. The method of claim 1 wherein the multimedia content is not available because a sufficient amount thereof has not been downloaded.

23. An Internet message delivery system, comprising:
a log-on system on a viewing station, wherein the viewing station further comprises a personal computer operatively connected to the Internet;
a processing system operatively connected to the viewing station through the Internet, wherein viewing information on the viewing of multimedia content of a first viewer and demographic information of the first viewer is delivered to the processing system through the Internet and wherein the processing system uses the viewing information and the demographic information to select a desired sponsored video message;
means for displaying, through the Internet, at a viewing station multimedia content for viewing by the first viewer; and
means for delivering the message to a viewing station through the Internet for viewing by the first viewer in conjunction with the viewing by the first viewer of the multimedia content.

24. (canceled)

25. The system of claim 23 further comprising:
means for delivering second-viewer demographic information on a second viewer to the processing system;
means for delivering to the processing system second-viewer viewing information on the viewing by the second viewer of multimedia content;
means for displaying at a viewing station multimedia content through the Internet for viewing by the second viewer;
wherein the processing system uses the second-viewer demographic information together with the second-viewer viewing information to select a desired second-viewer sponsored video message different from the message for the first viewer; and
means for delivering the second-viewer message to a viewing station through the Internet for viewing by the second viewer in conjunction with the viewing by the second viewer of the multimedia content.

26-27. (canceled)

28. The system of claim 23 wherein the viewing information includes viewing information on the first viewer every time the first viewer logs onto the processing system and views multimedia content.

29. The system of claim 23 further comprising means for pre-caching the message for presentation when the multimedia content is at least substantially not available for presentation at the viewing station.

30. The system of claim 29 wherein the pre-caching means is at the viewing station.

31. A message delivery system, comprising:
a log-on system on first and second viewing stations, wherein said viewing stations are operatively connected through the Internet to:
a multimedia content server;
a message server including a plurality of different sponsored video messages; and
a processing server which processes multimedia viewing information about a first viewer and therefrom selects a first message from the plurality of messages;
wherein the processing server also processes demographic information of the first viewer to select the first message;
the first station presenting the first message from the message server and multimedia content from the multimedia content server for viewing by the first viewer;
the processing server processing multimedia viewing information about a second viewer and therefrom selecting a second message from the plurality of messages;
wherein the processing server also processes demographic information of the second viewer to select the second message; and
the second station presenting the second message from the message server and multimedia content from the multimedia content server for viewing by the second server.

32. (canceled)

33. The system of claim 31 further comprising a recipient assembly which presents viewer/viewing information transmitted thereto by the processing server.

34. A processing server programmed to:
receive multimedia first-viewer viewing information and first-viewer demographic information relative to a first-viewer;
process the multimedia first-viewer viewing information and first-viewer demographic information to obtain first processed information, and associate the first processed information with a first sponsored video message from a database of messages for delivery to a first viewing station through the Internet for viewing by the first-viewer together with multimedia;
receive second-viewer multimedia viewing information and second-viewer demographic information relative to a second viewer; and
process the multimedia second-viewer viewing information and second-viewer demographic information to obtain second processed information and associate the second processed information with a second sponsored video message from the database for delivery to a second viewing station for viewing by the second-viewer together with multimedia, wherein said processing server and said first and second viewing stations are operatively connected through the Internet.

35. (canceled)

36. The server of claim 34 further programmed to transmit viewer/viewing information to a recipient assembly for presentation to a recipient.

37. A processing server, comprising:
means for receiving through the Internet first-viewer demographic information and first-viewer multimedia viewing information, both relative to a first viewer;
means for processing the first-viewer demographic information and first-viewer multimedia viewing information to obtain a first signal for delivery to a message server for selecting therefrom a desired first sponsored video message, the first message to be viewed by the first viewer at a viewing station logged onto by said first viewer;
means for receiving through the Internet second-viewer demographic information and second-viewer multimedia viewing information, both relative to a second viewer; and
means for processing the second-viewer demographic information and first-viewer multimedia viewing information to obtain a second signal for delivery to the message server for selecting therefrom a desired second sponsored video message, the second message to be viewed by the second viewer at a viewing station logged onto by said second viewer.

38. The server of claim 37 further comprising means for delivering viewer/viewing information to a recipient assembly for presentation to a recipient.

39. A presentation delivery method, comprising:
(a) logging in by a user to a viewing station;
(b) delivering a sponsored message over the Internet to the viewing station;
(c) pre-caching the delivered message at the viewing station;
(d) delivering multimedia content over the Internet to the viewing station;
(e) presenting the delivered multimedia content at the viewing station; and
(f) presenting the pre-cached message at the viewing station at a time when the multimedia content is at least substantially not available.

40. The method of claim 39 wherein (d) occurs at the same time as (f).

41. (canceled)

42. The method of claim 39 wherein the multimedia content is not available because a sufficient portion of the multimedia content has not been pre-cached.

43. The method of claim 39 wherein the multimedia content is not available because (d) includes a break in the delivering of the multimedia content.

44. A presentation delivery method, comprising:
(a) pre-caching a sponsored message at a viewing station operatively connected to the Internet;
(b) loading from the Internet at least a portion of multimedia content at the viewing station;
(c) during (b), presenting the sponsored message from the Internet at the viewing station to a viewer;
(d) after (c), presenting the multimedia content through the Internet at the viewing station to the viewer.

45. The method of claim 44 further comprising before (a), obtaining information relative to the viewer and based on the information, selecting the message so as to be specifically targeted to that viewer.

46. The method of claim 45 wherein the information includes prior multimedia viewing information of the viewer.

47. The method of claim 46 wherein the information further includes demographic information on the viewer.

48. The method of claim 44 wherein the sponsored message is a video message.

49-50. (canceled)
